(19) United States
(12) Patent Application Publication
(10) Pub. No.: US 2026/0350264 A1
(43) Pub. Date: Nov. 5, 2026

(54) METHOD FOR SIMPLIFICATION OF POWER MANAGEMENT PROGRAM AND POWER MANAGEMENT SYSTEM

(71) Applicant: LITE-ON TECHNOLOGY CORPORATION, TAIPEI CITY (TW)

(72) Inventors: Chia-mei Tang, TAIPEI CITY (TW); Tse-Chun Wang, TAIPEI CITY (TW)

(21) Appl. No.: 19/393,584

(22) Filed: Nov. 19, 2025

Related U.S. Application Data
(60) Provisional application No. 63/797,112, filed on Apr. 30, 2025.

(30) Foreign Application Priority Data
Aug. 25, 2025 (CN) 202511190445.5

(51) Int. Cl. G06F 30/20; G06F 1/28; G06F 113/04

(52) U.S. Cl. CPC G06F 30/20; G06F 1/28; G06F 2113/04

(57) ABSTRACT

A method for simplification of a power management program and a power management system. The method includes: establishing, by a simulation program, a simulation model of a power grid system; setting, by the simulation program, a target parameter of the simulation model; performing, by the simulation program, a power simulation on the simulation model. The power simulation includes: adjusting a power upper limit of one of controllable lines; collecting power generation information of the simulation model and power consumption information; determining, based on the power generation information and the power consumption information, whether or not the adjusted controllable line affects the target parameter, in which, if the adjusted controllable line affects the target parameter, the adjusted controllable line is a key line; and establishing, by an editing program, the power management program based on the at least one key line.

### CROSS-REFERENCE TO RELATED PATENT APPLICATION

This application claims the benefit of priorities to the U.S. Provisional Patent Application Ser. No. 63/797,112, filed on Apr. 30, 2025, and China Patent Application Ser. No. 202511190445.5, filed on Aug. 25, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an energy management system and an energy management method, especially for a method for simplification of power management program and a power management system.

### BACKGROUND OF THE DISCLOSURE

With continuous technological advancements, technology has found its way into many aspects of people’s lives, and there is a growing demand for smart homes.

A house is used as a platform for smart home technology, and integrates line layout technology, network communication technology, and automatic control technology to achieve an environmentally friendly and energy-saving living environment. Managing home power is a key component for achieving a smart home.

Currently, when a resident wants to use a power management service, a service provider must first install hardware devices in the resident's house, and then the service provider collects power data from the hardware devices. After collecting the power data, the collected power data must be filtered. Finally, the filtered power data is used to design the power management program. Because the collection and filtering of power data for the resident takes several months before the power management program can be designed, the power management program cannot be deployed and operational within a short timeframe.

### SUMMARY OF THE DISCLOSURE

The present disclosure provides a method for simplification of a power management program and a power management system, and primarily addresses the issue of prolonged data collection time to collect power data before designing the power management program, which delays the deployment of the power management program.

In order to solve the above-mentioned problems, one of the technical aspects adopted by the present disclosure is to provide a method for simplification of a power management program. The method includes: establishing, by a simulation program, a simulation model of a power grid system including a plurality of controllable lines, wherein each of the controllable lines has a power upper limit; setting, by the simulation program, a target parameter of the simulation model; performing, by the simulation program, a power simulation on the simulation model. The power simulation includes: adjusting the power upper limit of one of the plurality of controllable lines; collecting power generation information of the simulation model and power consumption information of the simulation model; determining, based on the power generation information and the power consumption information, whether or not the controllable line having the adjusted power upper limit affects the target parameter, in which, if the controllable line having the adjusted power upper limit affects the target parameter, the controllable line having the adjusted power upper limit is a key line; and establishing, by an editing program, the power management program based on the at least one key line.

In order to solve the above-mentioned problems, another one of the technical aspects adopted by the present disclosure is to provide a power management system. The power management system includes a processing circuit and a storage circuit connected to the processing circuit. The processing circuit accesses the storage circuit to execute the method for simplification of the power management program.

In summary, the method for simplification of the power management program and power management system of the present disclosure, based on the power simulation, the power management program is designed based only on key lines, and not based on all of controllable lines. Therefore, the content of the power management program is simplified to speed up the time required for the power management program to be put into service.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a power management system according to one embodiment of the present disclosure.

FIG. 2 is a schematic diagram of a power grid system according to one embodiment of the present disclosure.

FIG. 3 is a flow chart of a method for simplification of a power management program according to a first embodiment of the present disclosure.

FIG. 4 is a flow chart of establishing a simulation model of the power grid system in FIG. 3.

FIG. 5 is a flow chart of the power simulation of FIG. 3.

FIG. 6 is a comparison diagram of wasted solar energy between a simulation model with the power management program and another simulation model without the power management program.

FIG. 7 is a flow chart of the method for simplification of the power management program according to a second embodiment of the present disclosure.

FIG. 8 is a flow chart of a parameter confirmation procedure of FIG. 7.

FIG. 9 is a diagram showing a relationship between a first key parameter of the power management program and wasted solar energy.

FIG. 10 is a diagram showing a relationship between a second key parameter of the power management program and wasted solar energy.

FIG. 11 is a comparison diagram of wasted solar energy between a power management program with a parameter optimization and another power management program without the parameter optimization.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

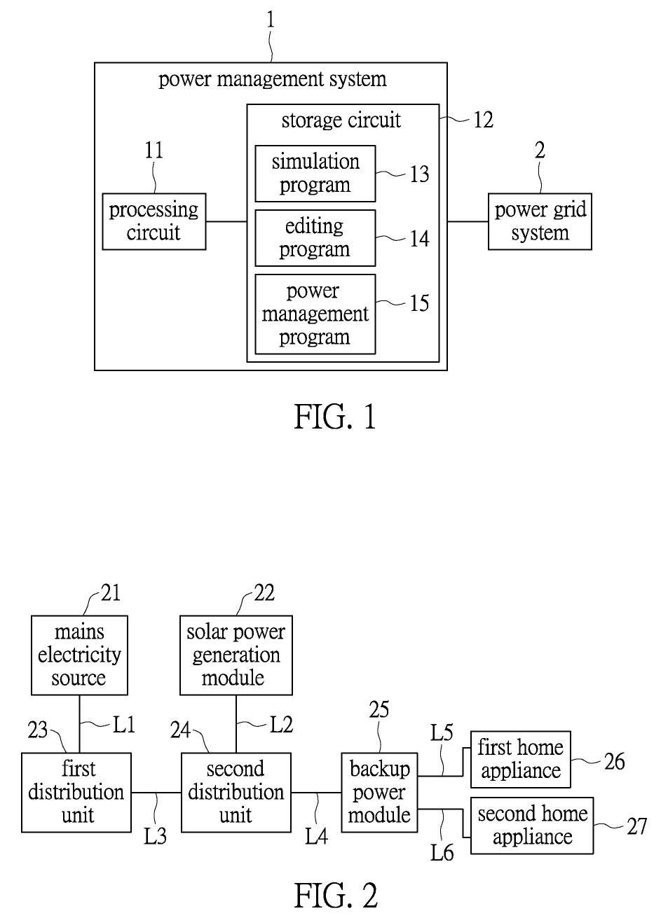

FIG. 1 is a schematic diagram of a power management system according to one embodiment of the present disclosure.

Referring to FIG. 1, a power management system 1 is connected to a power grid system 2 installed at a user's residence. The power management system 1 includes a processing circuit 11 and a storage circuit 12, and the processing circuit 11 is connected to the storage circuit 12. The processing circuit 11 is, for example, a central processing unit (CPU), and the storage circuit 12 is, for example, a random-access memory (RAM), a read-only memory (ROM), a flash memory, a hard drive, or other storage device capable of storing data.

The storage circuit 12 stores a simulation program 13 and an editing program 14. The processing circuit 11 is configured to access the storage circuit 12 to execute the simulation program 13. The simulation program 13 creates a simulation model of the power grid system 200. Users may set target parameters (e.g., wasted solar energy or electricity costs) of the simulation model through the simulation program 13. The simulation program 13 is configured to analyze at least one key line that affects the target parameters, where each key line is associated with one or a plurality of key parameters.

The processing circuit 11 is configured to access the storage circuit 12 to execute the editing program 14. Users use the editing program 14 to create a power management program 15 based on the plurality of key parameters analyzed by the simulation program 13, and the storage circuit 12 stores the power management program15 in the storage circuit 12. The processing circuit 11 is configured to access the storage circuit 12 to execute the power management program 15, thereby optimizing the target parameters.

FIG. 2 is a schematic diagram of a power grid system according to one embodiment of the present disclosure. Referring to FIG. 2, the power grid system 2 includes a mains electricity source 21, a solar power generation module 22, a first power distribution unit 23, a second power distribution unit 24, a backup power module 25, a first home appliance 26, and a second home appliance 27. The mains electricity source 21 outputs power to the first power distribution unit 23 via a first line L1, and the solar power generation module 22 outputs power to the second power distribution unit 24 via a second line L2. Each of the first power distribution units 23 and the second power distribution unit 24 may include an inverter, a transformer, a converter, and/or a power router, depending on its intended purpose. The first power distribution unit 23 outputs power to the second power distribution unit 24 via a third line L3, and the second power distribution unit 24 outputs power to the backup power module 25 via a fourth line L4. The backup power module 25 outputs power to the first home appliance 26 via a fifth line L5, and the backup power module 25 outputs power to the second home appliance 27 via a sixth line L6. In some embodiments, the second power distribution unit may be connected to an energy storage system. The second power distribution unit 24 may supply power to an energy storage system, or the energy storage system may supply power to the second power distribution unit 24.

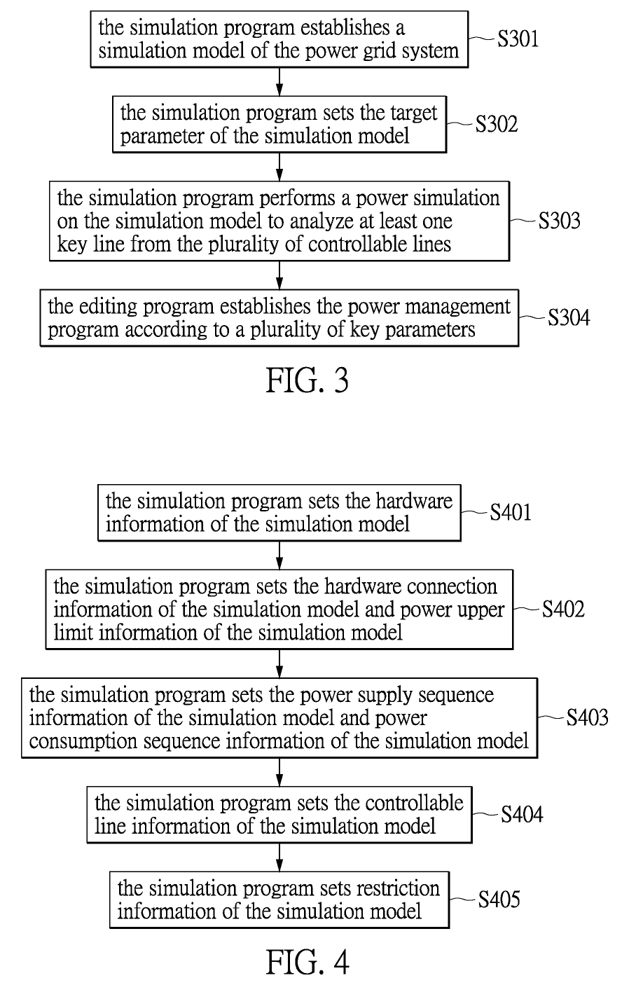

FIG. 3 is a flow chart of a method for simplification of a power management program according to a first embodiment of the present disclosure. In step S301, the simulation program 13 establishes a simulation model of the power grid system 200, in which the simulation model includes a plurality of controllable lines, and each controllable line has a power upper limit.

In step S302, the simulation program 13 sets the target parameter of the simulation model. Specifically, the target parameter is wasted solar energy.

In step S303, the simulation program 13 performs a power simulation on the simulation model to analyze at least one key line from the plurality of controllable lines, in which each key line associates with one or more key parameters, and the number of the at least one key line is less than the number of the controllable lines.

In step S304, the editing program 14 establishes the power management program 15 according to a plurality of key parameters. Specifically, since the design of the power management program 15 is only based on the at least one key line rather than being based on all of the controllable lines, it thereby achieves simplification of the power management program.

FIG. 4 is a flow chart of establishing a simulation model of the power grid system in FIG. 3. Referring to FIG. 4, in step S401, the simulation program 13 sets the hardware information of the simulation model. Specifically, the hardware information of the simulation model includes the mains electricity source 21, the solar power generation module 22, the first power distribution unit 23, the second power distribution unit 24, the backup power module 25, the first home appliance 26 and the second home appliance 27.

Regarding step S402, the simulation program 13 sets the hardware connection information of the simulation model and power upper limit information of the simulation model.

Specifically, the hardware connection information includes the first line L1, the second line L2, the third line L3, the fourth line L4, the fifth line L5, and the sixth line L6. The power upper limit information includes, for example, a power upper limit of the third line L3 is 10kW, a power upper limit of the fourth line L4 is 10kW, a power upper limit of the fifth line L5 is 7.6kW and a power upper limit of the sixth line L6 is 7.6kW.

In step S403, the simulation program 13 sets the power supply sequence information of the simulation model and power consumption sequence information of the simulation model according to the power grid system 200.

For example, the solar power generation module 22 takes precedence over the first power distribution unit 23 in supplying power to the second power distribution unit 24. The first home appliance 26 and the second home appliance 27 both use the power of the backup power module 26. The first home appliance 26 takes precedence over the second home appliance 27 in using the power of the backup power module 26.

In step S404, the simulation program 13 sets the controllable line information of the simulation model. Specifically, the first line L1 and the second line L2 are uncontrollable lines, and each of the third line L3 to the sixth line L6 is a controllable line.

In step S405, the simulation program 13 sets restriction information of the simulation model. For example, a remaining power percentage of the first home appliance 26 and a remaining power percentage of the second home appliance 27 cannot be less than 10%, and the power of the second line L2 is fixed at 10 kW.

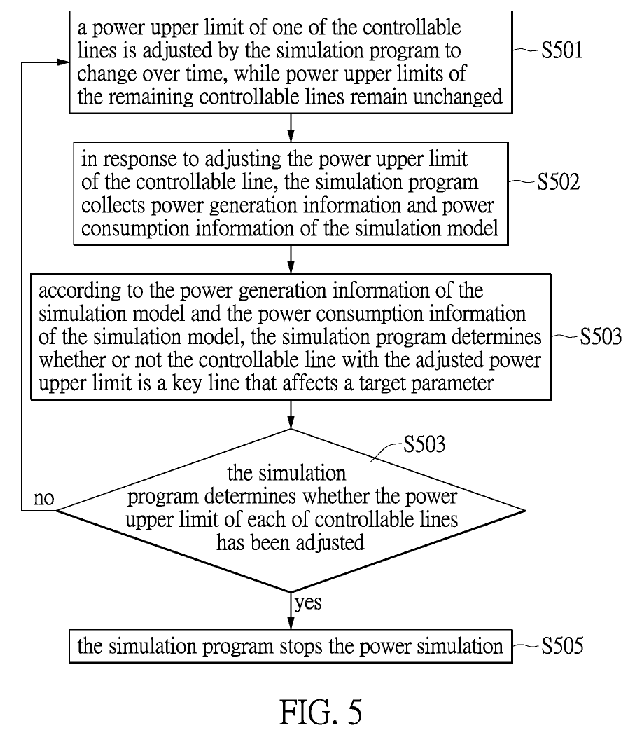

FIG. 5 is a flow chart of the power simulation of FIG. 3. Referring to FIG. 5, regarding step S501, a power upper limit of one of the controllable lines is adjusted by the simulation program 13 to change over time, while power upper limits of the remaining controllable lines remain unchanged.

Specifically, the third to sixth lines L3 to L6 are controllable lines. During the same time interval, when the power upper limit of the third line L3 varies over time, the power upper limits of the fourth line L4, the fifth line L5, and the sixth line L6 remain fixed. When the power upper limit of the fourth line L4 varies over time, the power upper limits of the third line L3, the fifth line L5, and the sixth line L6 remain fixed. When the power upper limit of the fifth line L5 varies over time, the power upper limits of the third line L3, the fourth line L4, and the sixth line L6 remain fixed. When the power upper limit of the sixth line L6 varies over time, the power upper limits of the third line L3, the fourth line L4, and the fifth line L5 remain fixed.

Regarding step S502, in response to adjusting the power upper limit of the controllable line, the simulation program 13 collects power generation information and power consumption information of the simulation model.

Specifically, when the power upper limit of the third line L3 changes over time and the power upper limit of each of the fourth line L4, the fifth line L5, and the sixth line L6 remain unchanged, the simulation program 13 collects first power generation information (power generation of the solar power generation module) and first power consumption information (the total power consumption of the first and second household appliances). When the power upper limit of the fourth line L4 changes over time and the power upper limit of each of the third line L3, the fifth line L5, and the sixth line L6 remain unchanged, the simulation program 13 collects second power generation information and second power consumption information. When the power upper limit of the fifth line L5 changes over time and the power upper limit of each of the third line L3, the fourth line L4, and the sixth line L6 remain unchanged, the simulation program 13 collects third power generation information and third power consumption information. When the power upper limit of the sixth line L6 changes over time and the power upper limits of each of the third line L3, the fourth line L4, and the fifth line L5 remain unchanged, the simulation program 13 collects fourth power generation information and fourth power consumption information.

Regarding step S503, according to the power generation information of the simulation model and the power consumption information of the simulation model, the simulation program 13 determines whether or not the controllable line with the adjusted power upper limit is a key line that affects a target parameter.

Specifically, when the wasted solar energy is set as a target parameter by a user, power difference between power generation of the solar power generation module and total power consumption of homes appliances is the target parameter. When the power upper limit of the third line L3 changes over time, the target parameter remains unchanged, indicating that the second line L3 is not a key line that affects the target parameter. When the power upper limit of the fourth line L4 changes over time, the target parameter remains unchanged, indicating that the fourth line L4 is not a key line that affects the target parameter. When the power upper limit of the fifth line L5 changes over time, the target parameter also changes over time, indicating that the fifth line L5 is a key line that affects the target parameter. When the power upper limit of the sixth line L6 changes over time, the target parameter also changes over time, indicating that the sixth line L6 is a key line that affects the target parameter.

Regarding step S504, the simulation program 13 determines whether or not the power upper limit of each of controllable lines has been adjusted.

If yes, the power simulation goes to step S505. If no, the power simulation returns to step S501.

Regarding step S505, the simulation program 13 stops the power simulation.

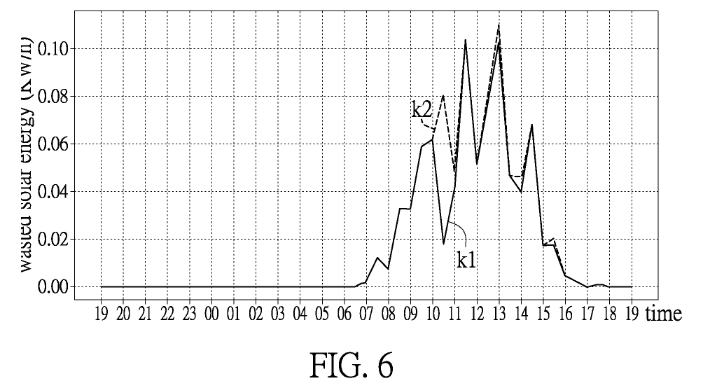

FIG. 6 is a comparison diagram of wasted solar energy between a simulation model with the power management program and another simulation model without the power management program.

Referring to FIG. 6, a curve k1 indicates a time sequence diagram of wasted solar energy of a simulation model using the power management program, in which a sum of the wasted solar energy of the simulation model during one day is approximately 23.977 kw/h. Conversely, a curve k2 indicates a time sequence diagram of wasted solar energy of another simulation model without the power management program, in which a sum of the wasted solar energy of the simulation model without the power management program during one day is approximately 26.574 kw/h. Therefore, the power management program can indeed reduce the sum of wasted solar energy.

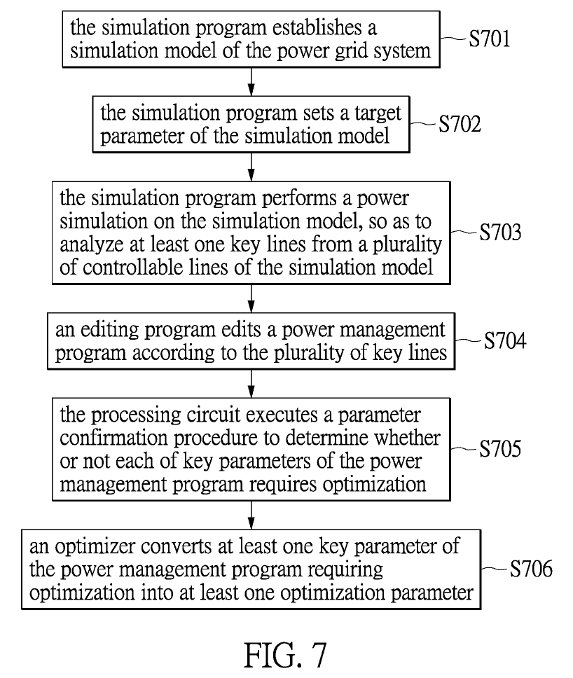

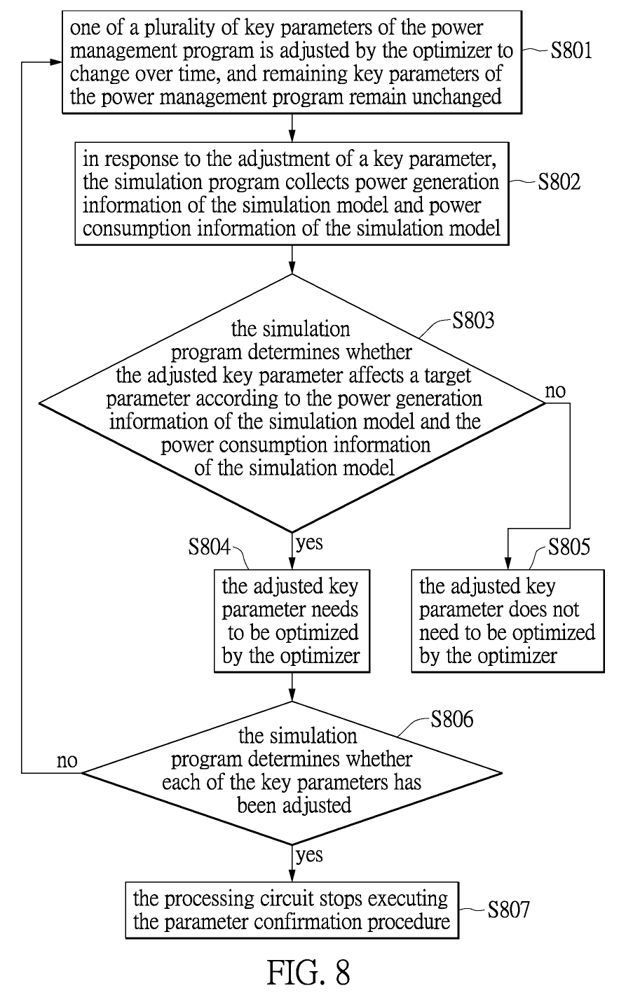

FIG. 7 is a flow chart of the method for simplification of the power management program according to a second embodiment of the present disclosure. Referring to FIG. 7, regarding step S701, the simulation program 13 establishes a simulation model of the power grid system 200, in which the simulation model includes a plurality of controllable lines, and each controllable line has a power upper limit.

Regarding step S702, the simulation program 13 sets a target parameter of the simulation model.

Regarding step S703, the simulation program 13 performs a power simulation on the simulation model, so as to analyze at least one key lines from a plurality of controllable lines of the simulation model.

Regarding step S704, an editing program 14 edits a power management program according to the plurality of key lines.

Regarding step S705, the processing circuit 11 executes a parameter confirmation procedure to determine whether or not each of key parameters of the power management program 15 requires optimization.

In step S706, an optimizer converts at least one key parameter of the power management program 15 requiring optimization into at least one optimization parameter. Specifically, the optimizer uses Broyden-Fletcher-Coldfarb-Shanno (BFGS) algorithm to optimize the at least one key parameter.

FIG. 8 is a flow chart of the parameter confirmation procedure of FIG. 7. Referring to FIG. 8, regarding step S801, one of a plurality of key parameters of the power management program 15 is adjusted by the optimizer to change over time, and remaining key parameters of the power management program 15 remain unchanged.

Regarding step S802, in response to the adjustment of a key parameter, the simulation program 13 collects power generation information of the simulation model and power consumption information of the simulation model.

Regarding step S803, the simulation program 13 determines whether the adjusted key parameter affects a target parameter according to the power generation information of the simulation model and the power consumption information of the simulation model.

If yes, the parameter confirmation procedure proceeds to step S804. If no, the parameter confirmation procedure goes to step S805.

Regarding step S804, the adjusted key parameter needs to be optimized by the optimizer.

Regarding step S805, the adjusted key parameter does not need to be optimized by the optimizer.

Regarding step S806, the simulation program 13 determines whether each of the key parameters has been adjusted.

If yes, the parameter confirmation procedure goes to step S807. If no, the parameter confirmation procedure goes to step S801.

Regarding step S807, the processing circuit 11 stops executing the parameter confirmation procedure.

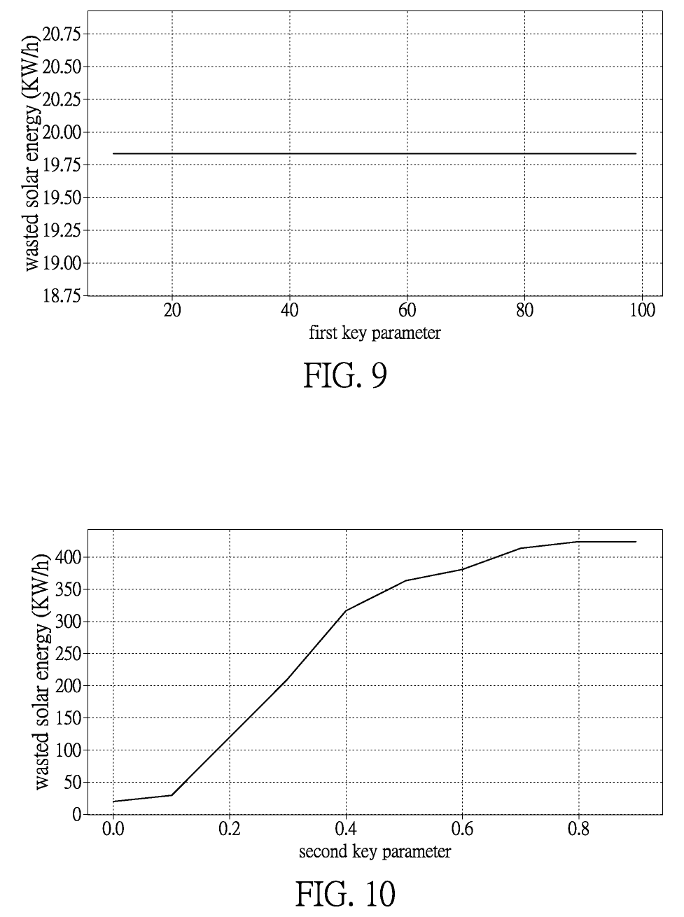

FIG. 9 is a diagram showing a relationship between a first key parameter of the power management program and the amount of wasted solar energy. Referring to FIG. 9, the first key parameter of the power management program 15 is a variable value, but the wasted solar energy of the simulation model remains unchanged, indicating that the first key parameter does not affect the wasted solar energy. Therefore, the first key parameter of the power management program 15 does not need to be optimized by the optimizer.

FIG. 10 is a diagram showing a relationship between a second key parameter of the power management program and the amount of wasted solar energy. Referring to FIG. 10, the second key parameter of the power management program varies over time, and the wasted solar energy of the simulation model also varies over time, indicating that the second key parameter affects the wasted solar energy. Therefore, the second key parameter of the power management program 15 needs to be optimized through an optimizer. The smaller the second key parameter, the lower the amount of wasted solar energy.

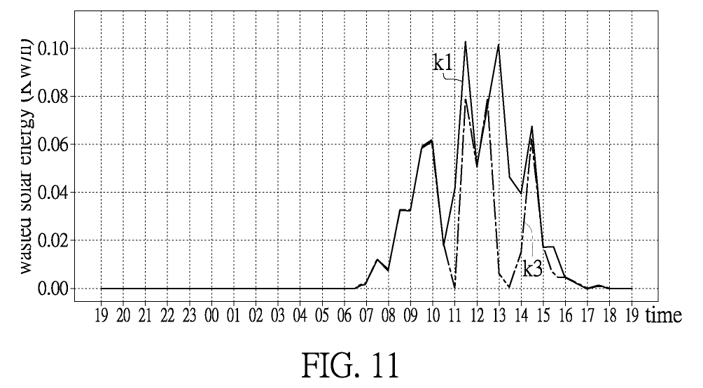

FIG. 11 is a comparison diagram of wasted solar energy between a power management program with a parameter optimization and another power management program without the parameter optimization. Referring to FIG. 11, the curve k1 indicates a time sequence diagram of wasted solar energy of a simulation model using the power management program, and a sum of the wasted solar energy of the simulation model during one day is approximately 23.997 kw/h. A curve k3 is a time sequence diagram of wasted solar energy of the simulation model using the power management program with parameter optimization. The sum of wasted solar energy of the simulation model during one day is approximately 16.401 kw/h. Therefore, the power management program with parameter optimization can indeed reduce the wasted solar energy.

### Beneficial Effects of the Embodiments

In conclusion, in the method for simplification of the power management program and power management system provided by the present disclosure, based on the power simulation, the power management program is designed based solely on key lines, rather than all of controllable lines. Therefore, the content of the power management program is simplified to accelerate the deployment of the power management program.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for simplification of a power management program, comprising:
establishing, by a simulation program, a simulation model of a power grid system including a plurality of controllable lines, wherein each of the controllable lines has a power upper limit;
setting, by the simulation program, a target parameter of the simulation model;
performing, by the simulation program, a power simulation on the simulation model;
wherein the power simulation includes:
adjusting the power upper limit of one of the plurality of controllable lines;
collecting power generation information of the simulation model and power consumption information of the simulation model;
determining, based on the power generation information and the power consumption information, whether or not the controllable line having the adjusted power upper limit affects the target parameter;
wherein, if the controllable line having the adjusted power upper limit affects the target parameter, the controllable line having the adjusted power upper limit is a key line;
establishing, by an editing program, the power management program based on the at least one key line.

2. The method according to claim 1, wherein establishing the simulation model of the power grid system includes:
setting, by the simulation program, hardware device information of the simulation model according to the power grid system.

3. The method according to claim 1, wherein establishing the simulation model of the power grid system includes:
setting, by the simulation program, hardware connection information of the simulation model and power upper limit information of the simulation model according to the power grid system.

4. The method according to claim 1, wherein establishing the simulation model of the power grid system includes:
setting, by the simulation program, power supply sequence information of the simulation model and power consumption sequence information of the simulation model according to the power grid system.

5. The method according to claim 1, wherein establishing the simulation model of the power grid system includes:
setting, by the simulation program, controllable line information of the simulation model according to the power grid system.

6. The method according to claim 1, wherein establishing the simulation model of the power grid system includes:
setting, by the simulation program, restriction information of the simulation model according to the power grid system.

7. The method according to claim 1, wherein the key line is associated with one or a plurality of key parameters, and the power management program is established by the editing program according to the plurality of key parameters.

8. The method according to claim 7, further comprising:
adjusting one of the plurality of key parameters;
determining whether or not the adjusted key parameter affects the target parameter; and
converting, by an optimizer, the adjusted key parameter into an optimized parameter when the adjusted key parameter affects the target parameter.

9. A power management system, comprising:
a processing circuit; and
a storage circuit connected to the processing circuit;
wherein the processing circuit accesses the storage circuit to execute the method according to claim 1.

10. The power management system according to claim 9, wherein the plurality of key parameters of the power management program are converted into a plurality of optimized parameters by an optimization process.
